(19) United States
(12) Patent Application Publication
(10) Pub. No.: US 2023/0419410 A1
(43) Pub. Date: Dec. 28, 2023

(54) REMOTE FARM DAMAGE ASSESSMENT SYSTEM AND METHOD

(71) Applicants: SRI International, Menlo Park, CA (US); WINGSURE INC., New York, NY (US)

(72) Inventors: Supun SAMARASEKERA, Skillman, NJ (US); Rakesh KUMAR, West Windsor, NJ (US); Garbis SALGIAN, Princeton Junction, NJ (US); Qiao WANG, New York, NY (US); Glenn A. MURRAY, Jamison, PA (US); Avijit BASU, Stamford, CT (US); Alison POLKINHORNE, Portola Valley, CA (US)

(21) Appl. No.: 18/035,845

(22) PCT Filed: Dec. 15, 2021
(86) PCT No.: PCT/US2021/063533

§ 371 Date: May 8, 2023

Related U.S. Application Data
(60) Provisional application No. 63/125,796, filed on Dec. 15, 2020.

(51) Int. Cl. G06Q 40/08; G06T 7/00; G06T 7/11; H04N 23/60

(52) U.S. Cl. CPC G06Q 40/08; G06T 7/0002; G06T 7/11; H04N 23/64; G06T 2207/30168; G06T 2207/20021; G06T 2207/30188; G06T 2207/20081

(57) ABSTRACT

Systems and methods for providing remote farm damage assessment are provided herein. In some embodiments, a system and method for providing remote farm damage assessment may include, determining a set of damage assessment locales for damage assessment; incorporating the set of damage assessment locales into a workflow; providing the workflow to a user device; receiving a first set of damage assessment images from the user device based on the workflow provided, wherein each of the first set of damage assessment images includes geolocation information and camera information; determining a damage assessment based on the first set of damage assessment images using a damage assessment machine learning model; and outputting a damage assessment indication including one or more of whether there is damage, a confidence level of assessing the damage, or a confidence level associated with the level of damage.

### CROSS-REFERENCE

This application claims benefit of U.S. Provisional Patent Application No. 63/125,796 filed Dec. 15, 2020, which is hereby incorporated by reference in its entirety.

### FIELD

Embodiments of the present principles generally relate to systems and methods for improved farm damage assessment and claims processing.

### BACKGROUND

Farmer insurance claims processing is primarily a manual process today. In most instances, the claims are processed on the basis of a claims processor visiting individual farms and manually evaluating the damage in the field and then processing the payout based on this assessment. Alternatively, the payout is triggered by more wide-spread catastrophic events where wide regions are categorized into a damaged region (flooding, drought etc.) and subsequently payouts are made.

Automating the assessment process has been difficult. There have been systems proposed based on robotic/drone platforms that view farms but not successfully implemented. Thus, there is a need for improved farm damage assessment and claims processing to speed up and automates the evaluation process with a focus on reducing claims assessors' workloads and costs.

### SUMMARY

Systems and methods for providing remote farm damage assessment are provided herein. In some embodiments, a system and method for providing remote farm damage assessment may include, determining a set of damage assessment locales for damage assessment; incorporating the set of damage assessment locales into a workflow; providing the workflow to a user device; receiving a first set of damage assessment images from the user device based on the workflow provided, wherein each of the first set of damage assessment images includes geolocation information and camera information; determining a damage assessment based on the first set of damage assessment images using a damage assessment machine learning model; and outputting a damage assessment indication including one or more of whether there is damage, a confidence level of assessing the damage, or a confidence level associated with the level of damage.

In some embodiments, a system and method for providing remote farm damage assessment on a mobile device may include initiating a request to assess crop damage via a mobile device; downloading a guidance workflow from a second device; requesting that a user of the mobile device go to each of the damage assessment locales using the downloaded guidance workflow on the mobile device; capturing a first set of damage assessment images in accordance with guidance from the customized guidance workflow; determining whether any of the first set of damage assessment images is not acceptable for use for damage assessment by analyzing quality of each of the first set of damage assessment images; and transmitting the first set of damage assessment images that are determined to be acceptable for use to assess damage to the second device.

In some embodiments, a system for providing remote farm damage assessment, comprising a farm sector selection module configured to determine a set of damage assessment locales for damage assessment; a script engine configured to incorporate the set of damage assessment locales into a workflow, wherein the system is configured to send the workflow to a user device; a damage assessment system configured to: receive a first set of damage assessment images from the user device based on the workflow provided, wherein each of the first set of damage assessment images includes geolocation information and camera information; determining a damage assessment based on the first set of damage assessment images using a damage assessment machine learning model; and outputting a damage assessment indication including one or more of whether there is damage, confidence level or both.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a remote farm damage assessment (RFDA) system in accordance with an embodiment of the present principles.

FIG. 2 depicts a high level workflow diagram of a systematic approach for allowing a farmer to identify damage to his crops while centralizing an assessment process in accordance with at least one embodiment of the present principles.

FIG. 3 depicts a detailed workflow diagram of a systematic approach for allowing a farmer to identify damage to his crops while centralizing an assessment process in accordance with at least one embodiment of the present principles.

FIG. 4 depicts assessor-in-the-loop machine learning framework in accordance with at least one embodiment of the present principles.

FIGS. 5A and 5B depict open-set recognition architectures in accordance with at least one embodiment of the present principles.

FIG. 6 depicts a high-level block diagram of a computing device suitable for use with embodiments of a remote farm damage assessment (RFDA) system in accordance with the present principles.

FIG. 7 depicts a high-level block diagram of a network in which embodiments of a remote farm damage assessment (RFDA) system in accordance with the present principles, such as the container security system of FIG. 1, can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to systems and methods for improved farm damage assessment and claims processing. More specifically, described herein are embodiments of systems and related methods where a farmer is guided to collect images or representations or information and images of the damaged crop, and assessors can work in a centralized location (e.g., in a call center type model) to make a final decision. Scalability of this approach lies in the notion that most farmers carry mobile phones with cameras and can provide the data required for assessment given the proper guidance. The disclosed system and methods improve upon the manual assessment model by bringing in machine learning methods to build upon the assessors' evaluations. This speeds up and automates the evaluation process with a focus on reducing assessors' workloads and costs.

An outline of the framework where both the local evaluation and information on global events (environmental and other social-economic events) that can be brought into the decision processes is provided below. The system and methods are capable of adapting to different crops, regional conditions, and other different conditions that enable backend processes to dissect the data in different ways to define ML based components. This effectively improves the workflow of assessment and payouts.

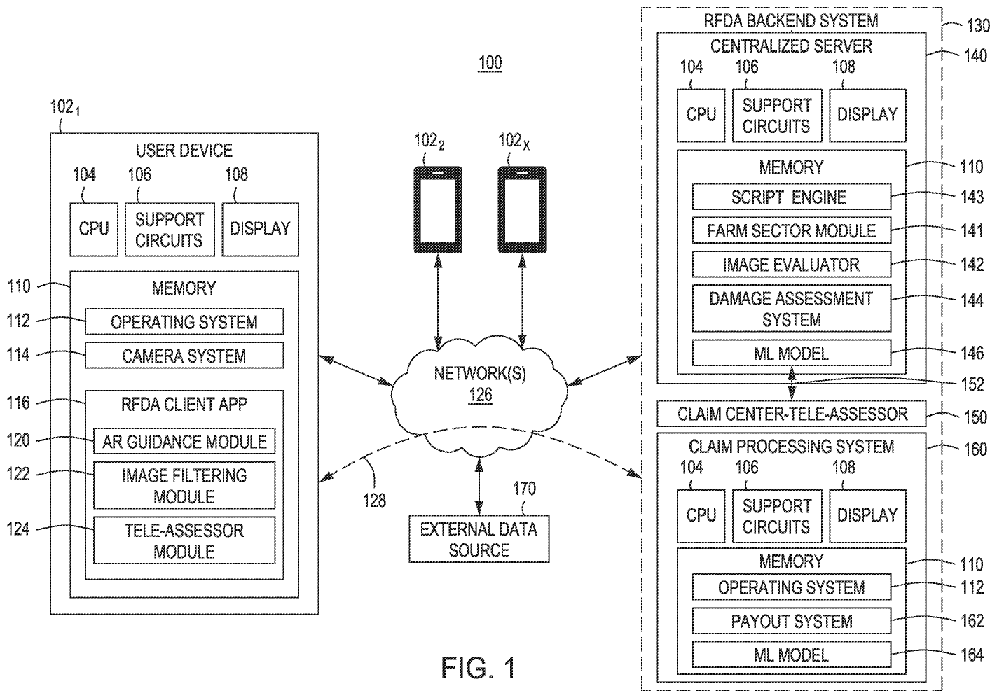

FIG. 1 depicts a block diagram of a remote farm damage assessment (RFDA) system 100 in accordance with at least one embodiment of the disclosure. Although discussed throughout as damage assessment, the RFDA system 100 described herein can equally be used for identifying conditions that are related to damages, e.g., crops standing in water. The system 100 includes a plurality of user devices 102, a RFDA backend system 130 that includes a centralized server 140, a tele-assessor call center 150, and a claims processing system 160 communicatively coupled via one or more networks 126. In some embodiments, information from external data sources 170 may be used in the remote farm damage assessment processes and systems described herein. In some embodiments, the components and users of the RFDA backend system 130 are configured to communicate with the user device 102 directly or indirectly via networks 126 (e.g., via communications 128).

The networks 126 comprise one or more communication systems that connect computers by wire, cable, fiber optic, and/or wireless link facilitated by various types of well-known network elements, such as hubs, switches, routers, and the like. The networks 108 may include an Internet Protocol (IP) network, a public switched telephone network (PSTN), or other mobile communication networks that support various types of mobile communications, and may employ various well-known protocols to communicate information amongst the network resources.

The end-user device (also referred to as “user device”) 102 comprises a Processing Unit 104, support circuits 106, display device 108, and memory 110. The end-user device 102 may be a mobile phone, tablet, laptop, AR goggles or wearables, or any other mobile processing device that includes the ability to obtain images/videos. In some embodiments, the end-user device 102 may be multiple devices connected to each other, for example, such as a mobile phone or tablet and an external image capturing device connected to each other. The Processing Unit 104 may comprise one or more commercially available microprocessors or microcontrollers that facilitate data processing and storage (e.g., CPU, GPU Tensor Processing Unit (TPU), Programmable Logic Controller (PLC), etc.). For convenience, the Processing Unit 104 is generally referred to as a CPU herein. The various support circuits 106 facilitate the operation of the CPU 104 and include one or more clock circuits, power supplies, cache, input/output circuits, and the like. The memory 110 comprises at least one of Read Only Memory (ROM), Random Access Memory (RAM), disk drive storage, optical storage, removable storage and/or the like. In some embodiments, the memory 110 comprises an operating system 112, camera app 114, and an RFDA client app 116. In some embodiments, the RFDA client app 116 includes an augmented reality (AR) guidance module 120 (in one embodiment, also referred to herein as AR Mentor), an image filtering module 122, and a tele-assessor communication module 124. In some embodiments, the RFDA client app 116 may be implemented as a remote website or cloud based service that the user remotely accesses via a web browser application to perform the assessment process. The functions of the AR Guide guidance module 120, image filtering module 122, and tele-assessor communication module 124 may be implemented through the remote website/cloud based service.

As discussed above, the RFDA backend system 130 includes a centralized server 140, a tele-assessor call center 150, and a claims processing system 160. In some embodiments, these components of the RFDA backend system 130 may operate on the same server and used by the same operators, or they may be employed as a distributed architecture used by the same or different operators. The centralized server 140 comprises a Processing Unit (CPU), support circuits, display device, and memory (similar to those described above with respect to end-user device 102). In some embodiments, the memory includes a farm sector selection module 141, an image evaluator 142, a damage assessment system 144, and an image evaluation and damage assessment machine learning model 146. In some embodiments, the image evaluation ML model may be a different ML model than the damage assessment ML model. In other embodiments, the same ML model may be used for both image evaluation and damage assessment. In some embodiments, the damage assessment machine learning model 146 used by the system may depend on the type of crop, vegetative state, environment, location, weather, etc.

The tele-assessor call center 150 may be operated by live operators to assist and guide the end user through the remote farm damage assessment process. In some embodiments, the tele-assessor call center 150 may also employ the use of bots or other automated systems to help guide end users through the remote farm damage assessment process. In some embodiments, operators at the tele-assessor call center 150 may manually review images determine quality of the images and if new images are required, locations or sections of a property/farm included in the images, the types of crops in the images, seasons or dates, crop damage, or other information from the images. The operators will tag/label/annotate the images, or portions thereof, to indicate crop information determined above through their manual review (e.g., crop damage, and crop health and condition). In some embodiments, those images and the associated labels/annotations may be fed back as shown by communication 152 to the image evaluation and damage assessment ML Model 146 to train the model to enhance the ML Model's ability to automatically evaluate images and determine crop damage assessment. In some embodiments, the damage assessment ML Model 146 is trained using one or more of annotated images described above, unsupervised learning, a mixture of annotated and unannotated data, or images annotated at a portion level of an image level or entire image.

The claims processing system comprises a Processing Unit (generally referred to as a CPU), support circuits, display device, and memory (similar to those described above with respect to end-user device 102 and centralized server 140). In some embodiments, the memory includes a claim payout system 162 and a claim processing machine learning (ML) model 164.

The operating system (OS) 112 in each of the user device 102, centralized server 140, and claims processing system 160 generally manages various computer resources (e.g., network resources, file processors, and/or the like). The operating system 118 is configured to execute operations on one or more hardware and/or software modules, such as Network Interface Cards (NICs), hard disks, virtualization layers, firewalls and/or the like. Examples of the operating system 118 may include, but are not limited to, various versions of LINUX, MAC OSX, BSD, UNIX, MICROSOFT WINDOWS, IOS, ANDROID and the like.

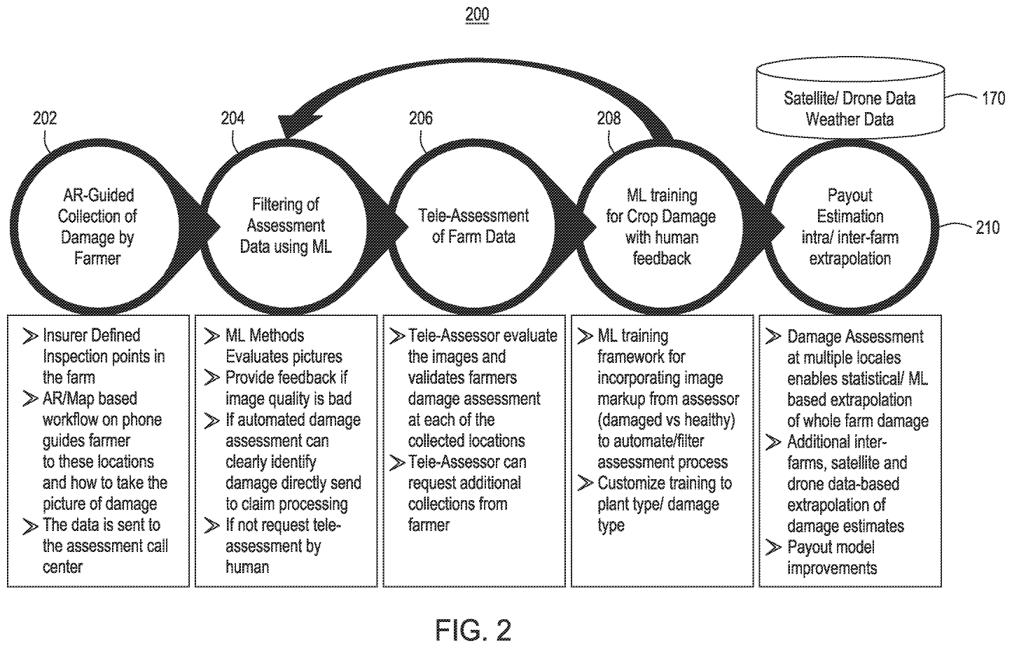

FIG. 2 shows a workflow diagram of at least one possible embodiment of a systematic assessment process 200 implemented via a remote farm damage assessment (RFDA) system 100 that enables a farmer to identify damage to his crops while centralizing an assessment process. The following are actions that may be taken in the assessment process 200 using the RFDA system 100.

AR-Guided collection of damage by farmer: The assessment process 200 begins at 202 where the RFDA system 100 enables one or more farmers to provide data using end user devices 102, for example, such as a mobile phone/processor. Once the user activates the RFDA client app 116, the AR Guidance module 120 will guide the user through the RFDA process. The system 100 uses prior knowledge about the farm and cultivation to guide the farmer through a systematic process of data collection. The guidance would enable reduction of fraud and ensure the farmer is collecting data that helps the assessment process. At 202, the AR-Guided collection of data includes guiding the user via the RFDA client app 116 through an AR/map based workflow on the user device that guides the user to RFDA backend system 130 defined inspection points on the insured property (e.g., the farm). The AR/map based workflow on the user device would guide the user how to take pictures of the damage via their mobile device so that it can be sent to a second device such as the RFDA backend system 130 (e.g., the centralized server 140 and/or the tele-assessor call center 150). In some embodiments, the second device may be located on the mobile device itself, or separately, on a separate computer nearby or a central server (e.g., a server on the RFDA backend system 130).

Filtering of assessment data: At 204, the image filtering is performed by an automated ML based process to first analyze the data collected to automatically determine the quality of the images collected. In some embodiments, a first level of image evaluation to determine image quality is performed by the image filtering module 122 on the end user device 102. The image filtering module 122 will analyze the images and provide feedback to the user if the image quality is bad or is acceptable. In other embodiments, in addition to, or instead of, the image evaluation performed by image filtering module 122, the images captured by the user are sent to the centralized server 140 where image evaluator 142 will analyze the images and provide feedback to the user if the image quality is bad or is acceptable. In some embodiments, the images captured by the user are sent to a second device which may be located on the mobile device itself, or separately, on a separate computer nearby or a central server (e.g., another server on the RFDA backend system 130). In some embodiments, both image filtering module 122 and image evaluator 142 may use ML model algorithms and methods to analyze the images and automatically make a determination of image quality. In some embodiments, filtering of assessment data/images includes filtering based on camera pose, ensuring that the right orientation is being used to capture the crop damage, given type of crop, vegetative state, etc. These elements are conveyed to the image analytics via image metadata from the AR Guidance module 120. In some embodiments, RFDA client app 116 may also performed some level of automated damage assessment. In other embodiments, damage assessment is performed by the damage assessment system 144 to automatically identify the damage from the pictures. The automated process for damage evaluation can replace the more labor-intensive manual assessment. If the automated damage assessment performed by the RFDA client app 116 or damage assessment system 144 on the centralized server 140 can clearly identify damage, the information is sent directly to the claim processing system 160 for further analysis to determine a payment amount. If damage from the automated damage assessment cannot be clearly identified, the information is sent to the tele-assessor call center 150 for human assessment.

Tele-assessment of farm data: At 206, if the ML process is unable to automatically assess the damage, the farm data is passed to a tele-assessor working at the call center 150. This data may be transmitted to the call center 150 systems for access by the tele-assessor operators by the tele-assessor communication module 124 on the end user device 102 and/or by the centralize server 130. The human tele-assessor evaluates the images and associated information and validates the property damage. In the process the assessor can request further collections from the farmer via messages through the RFDA client app 116 (e.g., a chat session via the tele-assessor communication module), text message, via phone call, or other modes of communication. Assessor reasoning (including tagging on images) are passed to the damage assessment ML model 146 for training at 208.

ML training for crop damage with human feedback: At 208, the assessor's input with the images (e.g., tags, labels, annotations) is fed to the ML model 146 which includes a training system to update the automated process used at 204. The incremental learning framework allows the system to continuously learn and improve its damage assessment using assessor input as ground truth. The process can be additionally bootstrapped by collecting and annotating some preliminary collections. The trained ML methods may include methods to detect when a correct determination cannot be made to ensure such data can be forwarded to the assessor for manual evaluations. This enables customized training of the ML models 146 to learn plant types and damage types.

Payout estimation intra-farm and inter-farm extrapolation: At 210, payment estimation is determined using claim payout system and claim processing ML model 164 of the claim processing system 160 using additional sources of data that can influence the farm payout assessment. Global events such as drought or floods affect many farms. Knowledge of these events can be used to guide the assessment process. Weather metadata or information obtained from external sources 170 (i.e. satellite imagery, drone imagery) can be analyzed to guide the assessment and payout conditions. Such data can provide additional inputs to 204 as an additional criterion to the automated processing. This data can be also used to interpolate the damage assessment from a few sampled locations or sample farms to additional locales (inter or intra farm). The interpolation can be done using traditional statistical techniques or ML based learning. With multi-year data such methods can be improved to better estimate overall damage and/or payouts. Furthermore, damage assessment at multiple locales enables statistical/ML bases extrapolation of the whole farm damage by damage assessment ML model 146 and/or the claim processing payout ML model 164.

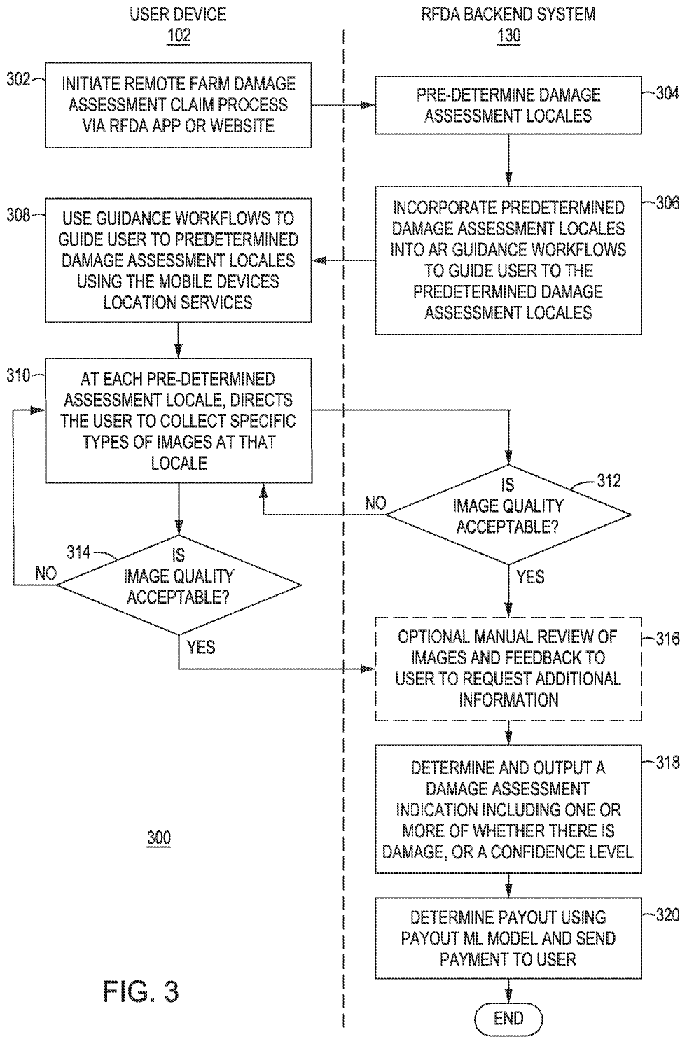

AR Guidance: The disclosed RFDA system 100 and assessment methods provide for farmer collection of damage data with AR guidance. As mentioned above, currently when a farmer submits a farm damage claim to his insurance, an assessor physically conducts a site survey to determine damage to the farm. Typically, the assessment process involves the assessor determining a set of sectors in the farm for inspection and randomly selecting a subset of these sectors to gather data. The number of sectors selected is generally determined by the farm size. In the disclosed system and method, while the on-site assessment process is pushed to the farmer, where the farmer would use a smart phone to capture necessary data, the assessment process cannot be left completely to the farmer. Farmers may lack the understanding of exactly the type of data the insurer requires for assessment. It is also possible a farmer may misuse the system to provide false claims. As such, to ensure proper data collection a guided process is used where the collection parameters are a set by the insurer (or assessor). The disclosed RFDA system 100 can provide guidance as exemplified above with respect to assessment process 200 described above at a high level, and with respect to the assessment process 200 and 300 of FIG. 3 described below in further details.

The damage assessment process 300 begins at 302 where an RFDA claim is initiated via the RFDA app 116 or via a website hosting the RFDA app. When a user (e.g., a farmer) first signs up with an insurance carrier, the insurance carrier will obtain information from the user about their property asset (e.g., farm), such as geolocation of the property, type of crops, geolocation of the areas of crops, and other information pertinent to the property assets and the crops/assets located on the insured property. That information is stored in association with the first property in memory structures such as a database on the RFDA Backend System 130 (e.g., in memory on the centralized server 140). Thus, the insurance carrier already has information regarding the insured property prior to the user initiating a damage claim at 302 by launching the RFDA client app 116 on their user device 102. In some embodiments, information such as crop type and crop stage will be passed via the RFDA app at the time of image capture, since these may change based on season, and based on the time and type of damage. The farmer/user may describe what crops they typically plant at registration, but the information used for the ML model pipelines (e.g., camera orientation, which damage assessment model to use) is passed in at the beginning of that ‘image capture for claim’ workflow.

Once the claim is initiated, at 304, the RFDA backend system 130, and specifically the farm sector selection module 141, will pre-determine damage assessment locales to be inspected and analyzed. As used herein, the pre-determined damage assessment locales include both position and orientation of the viewpoint of the picture. The pre-determined damage assessment locales could specify multiple damage assessment images (with different orientations/viewpoints) at a location. In some embodiments, the farm sector selection module 141 would automatically pre-determine (using geographic coordinates) the sectors of interest by employing one or more different algorithms that can automate this selection process. In other embodiments, a tele-assessor from call center 150 may be consulted to verify, modify, or augment the pre-determined locales. When a farmer initiates a claim process at 302, a subset of these points would be selected by the system for active inspection at 304. The selected subset can be all the sectors of the farm, or a randomly selected subset of the sectors. In addition to assessor selected locales, other conditions such as global weather patterns and assessments can inform the selection process. In some embodiments, the algorithms and ML models used to pre-determined damage assessment locales may be based on expert knowledge and/or agricultural heuristics or other well-known damage assessment location analysis techniques.

In some embodiments, the one or more different algorithms and ML models used to pre-determined damage assessment locales may be based on information from crop cutting experiments (CCE), which are run by government entities every year to determine the yield on farms. CCEs refer to an assessment method employed by governments and agricultural bodies to accurately estimate the yield of a crop or region during a given cultivation cycle. The traditional method of CCE is based on the yield component method where sample locations are selected based on a random sampling of the total area under study. Once the plots are selected, the produce from a section of these plots is collected and analyzed for a number of parameters such as biomass weight, grain weight, moisture, and other indicative factors. The data gathered from this study is extrapolated to the entire region and provides a fairly accurate assessment of the average yield of the state or region under study. Specifically, for assessment, images are taken from each of the four corners of the farm, and then of damaged quadrants, etc. These practices are used to derive the correct camera poses for each damage type (e.g., unseasonal/cyclonic rains with heavy wind, hailstorm damage, low temperature damage, post-harvest loss), for each crop type, for each vegetative stage. For example, based on the age and/or height of the crop, different camera poses and how to capture images may be determined by the algorithms and/or ML models.

At 306, based on the selection of sectors at 304, the RFDA system 100 automatically configures a guidance workflow for the farmer to follow. The customized guidance helps guide the user to multiple locations within a crop field, based on farm conditions because a farmer's understanding of assessment needs and use of their mobile phone technology may be limited. Having an AR guidance component can significantly improve the collection of data for damage assessment. In some embodiments, the guidance workflow that incorporates the damage assessment locales is created by a scripting engine 143 on the centralized server 140, or on a second device which may be located on the user device itself, or separately, on a separate computer nearby or a central server (e.g., another server on the RFDA backend system 130). Those workflows are then sent to, or downloaded by, the RFDA client app 116. In other embodiments, the damage assessment locales are sent to the RFDA client app 116 where the AR Guidance Module 120 will act as the script engine to create the guidance workflow for the farmer to follow based on the information received. In some embodiments, the centralized server acts as a web server and the RFDA client app 116 the information stored/created there. So the farmer can login into the RFDA system 100 via the RFDA client app 116, and the scripts will be downloaded to AR Guidance module 120 to guide that particular farmer to points on his field.

In some embodiments, the script engine 143 and/or AR Guidance Module 120 is a Unity game engine, or other type of scripting engine. In one embodiment, the system and methods can use an existing AR system such as SRI International's AR Mentor system. AR-Mentor system is a scripting engine run within a game engine (Unity). AR-Mentor combines location services and camera services on a mobile device to provide simple script-based workflows without having to program and customize software for every farm, every crop type and damage condition. The AR-Mentor scripting engine provides the capability to display live video with augmented reality overlays/objects on the mobile device screen, providing guidance to the user. Instructions are provided through the augmented reality overlays as onscreen text and audio through a text-to-speech engine. The AR-Mentor scripting engine allows guidance through a step-by-step workflow providing conditional branching, based on user actions, to follow alternate steps. This allows for creation of complex workflows that incorporate insurer proprietary assessment techniques or guidelines. The ability to define simple variables allows the system to customize key parameter such as farm locales, plant, etc. without having to customize the scripts for every situation. In some embodiments, it is possible to use commercially available language translation modules (text-to-text, text-to-speech and speech-to-text) to plug into the scripting framework to enable adaptation of the instructions and farmer input to the language used by the farmer. In some embodiments, a custom layer from the AR-Mentor Guidance system to the backend insurance servers is used to update per farm specific information and provides collected data and damage assessment images back to the server.

At 308, the user of the user device is requested to go to each of the damage assessment locales using the downloaded guidance workflow on the user device. In some embodiments, the guidance workflows are used by the AR Guidance module 120 to guide the user to the predetermined damage assessment locales using the user device's 102 location services. Those location services may include GPS, NFC, Wi-Fi, Bluetooth, and the like. The guidance may be an overlay on a map and/or use a mapping application (e.g., Google Maps, Apple Maps, Waze, MapQuest, etc.). In some embodiments, the guidance may be in the form of AR guidance and/or guidance provided via a video view. The guidance workflows used by the AR Guidance module 120 will take the following into consideration: some phones may not have some or all location services available or enabled. If no location services are available a map of the farm with the marked-out points can be generated to guide the farmer. If geo-position information is available a dynamic map display will show the farmer's current location and where he should move to, using animated icons for guidance. If available, compass information is also incorporated in providing guidance to the farmer. Thus, the guidance work flows created by the scripting engine may be customized for a specific user, user device, property, type of crop, growth stage, damage type, geolocation, and the like.

At 310, when the farmer reaches a sector (i.e., a predetermined damage assessment locale) using the AR Guidance module 120, the AR Guidance module 120 directs the user to collect specific types of damage assessment images at that locale. The data collection procedure that guides the user as to what damage assessment images to take will take into account the data that is best suited for automating the damage assessment process. The damage assessment images captured will also depend on various factors exemplified below:
Crop type: Each crop type may require set(s) of images that best inform the damage. It can, for example, have a different process for a vine, a bush or a tree.
Crop growth/age: Base in the age of the cultivation the pictures taken may have different requirements. If the plant is taller, the standoff distance and height and angle of the camera may need to be different.
Crop density: Distance between plants and distance between cultivation lines may affect how many pictures and how many plants are photographed.
Damage type: Farmer described crop damage may also influence the pictures to be taken. For example, the pictures taken for flood damage may be different from pictures taken for drought damage. Images for pest damage or germination failure may require close-ups/zoomed in images to see. Germination failure images may require images of an area where a plant should be (which will be compared with images of what the crop/plant should look like).

At 312, the images that are collected, along with location and camera information, will be sent to the image evaluator 142 on the centralized server 130, or to a second device which may be located on the user device itself, or separately, on a separate computer nearby or a central server (e.g., another server on the RFDA backend system 130), for further analysis including an assessment of quality of the collection. The location and camera information will include geo-graphic location, heading, pitch and tilt of the camera and other information of collection time (time, day, light levels, camera settings, phone type, current temperature, etc.). In some embodiments, the camera information included with each of the damage assessment images includes one or more of heading of the camera, pose, pitch of the camera, tilt of the camera, image collection date and time, light levels, camera settings, or phone type. Based on the automated assessment, the farmer may be provided with feedback and asked to take additional pictures through the AR-Guidance system back at 310. In some embodiments, a rapid check on the images taken to give immediate user feedback at 314 by the image filtering module 122 may be performed instead of, or in addition to, the image quality assessment performed at 312 by image evaluator 142. Since image quality can be determined based on type of phone (i.e., processor power, type of image capture hardware/software, etc.), in some embodiments, that type of phone and associated camera may dictate if one or both image evaluation checks at 312 and 314 are performed. For example, for an outdated phone or phone with low processing power or a bad image capture device, image evaluation may only be performed on the backend by image evaluator 142, while for better phones with better image capture ability, image evaluation may be performed on the client side image filtering module 122.

The image quality check performed by image filtering module 122 and/or image evaluator 142 can include image blur, lighting, occlusion, bad angles, crop centering, etc. It may also include check on locations in which the photos were taken and if it is consistent with guidance provided. More specifically, the collected images are evaluated to ensure that they are of sufficient quality for automated damage assessment. If an image does not meet the quality requirements the farmer will be asked to retake that picture. Specifically, the images are checked for:
Image quality: For each captured image the system will compute a score for sharpness (focus), and overall exposure (based on brightness and contrast).
Camera pose: images in the sequence collected at each location need to be taken from different heights and viewing directions. The system will check whether the collected data matches the specifications. Camera orientation will be determined from metadata (e.g. phone accelerometer data) recorded during image capture.

Based on the automated assessment, if the calculated quality scores for an image do not exceed a quality threshold, the farmer may be provided with feedback and asked to take additional pictures through the AR-Guidance system back at 310.

In some embodiments, the image evaluator 142 may also evaluate the image for fraud at 314. Specifically, the image evaluator 142 may use location information associated with the image (e.g., a GPS or other geolocation tag associated with the images) to protect against fraud to ensure pictures aren't taken at another locale in order to game the system.

At 316, in some embodiments, in addition to the image quality checks performed at 312 and 314, additional follow up actions by the farmer may optionally be recommended by the system. This would be based on a real assessor's feedback or analysis from the automated backend systems.

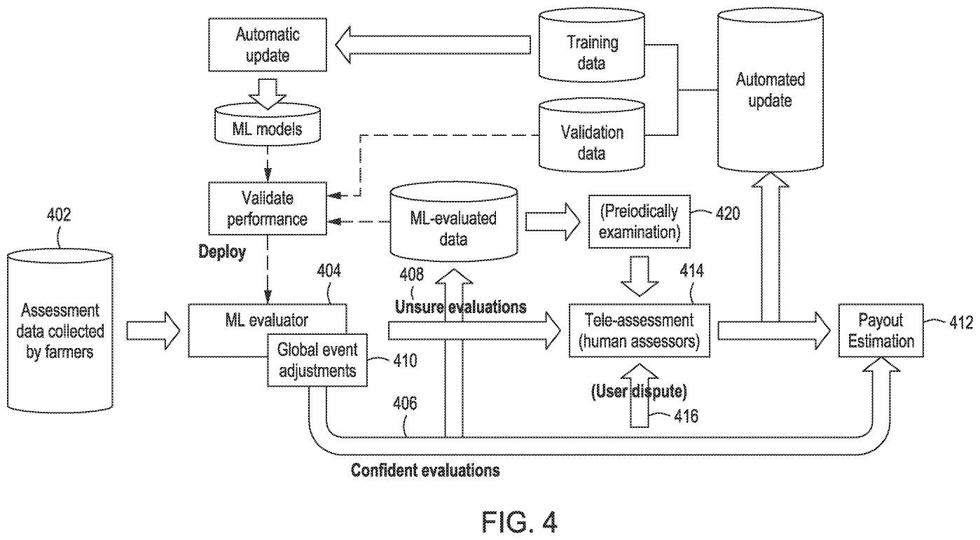

At 318, the damage assessment system 144 uses the damage assessment ML model 146 to determine the damage of the crops or the property identified. In some embodiments, the type of damage assessment ML model 146 used by the system may depend on the type of crop, vegetative state, environment, location, weather, etc. The damage assessment system 144 uses the damage assessment ML model 146 to output a damage assessment indication including one or more of whether there is damage and/or a confidence level. The confidence level may be a damage degree percentage. In some embodiments, if the confidence level is below a certain level, the information will be sent to tele-assessor call center 150 for manual analysis of damage, as described below in further detail with respect to ML evaluator 404 in FIG. 4. In some embodiments, the confidence level threshold is configurable and may be based on business goals. The confidence level required to consider a given image as representing “damage” or as requiring an assessor to step in can be tuned (e.g., can be a sliding scale depending on various factors).

In some embodiments, when the farmer captures a damage assessment image of the field, the damage assessment system 144 and the damage assessment ML model 146 may not reach a decision on damage based on the entire image submitted. Instead, for better performance, the system may look at or define a region of interest (ROI) and make damage assessment decisions only based on the content within the ROI. This ROI can be configured by parameters in the system, and can also be integrated with the AR Guidance module to be shown live when the farmer is taking the picture via the workflows sent to the user device. If needed, ROI can cover the entire image too. The reasons for excluding parts of an image may include one or more of: the area is too far away from camera, may not have enough details to make good decisions, crops near the edge of an image may be partly cropped or have large distortion, etc.

While it is possible to use the entire ROI or damage assessment image directly to reach decisions such as whether or how much damage is present, because an image usually contains many plants, other objects, and appearance-affecting factors, the possibility grows exponentially. So using the entire ROI/image directly would require an enormous amount of data to train an accurate model. Instead, the RFDA system divides the ROI into smaller regions/patches, and use these smaller patches of images for training models and for inference. This greatly reduces the requirement for training data and improves the reliability of the models. The system then aggregates the results of these smaller patches to reach image-level decisions. The aggregation process is configurable and also interpretable to humans so quite easy to adjust according to business need (e.g., reducing false positive rate or forwarding fewer images to human assessors).

In other embodiments, object detection or instance/semantic segmentation may be used to identify individual crops and handle damage assessment separately (e.g., using different models for each).

In some embodiments, the damage assessment system 144 and ML model 146 cannot determine damage based on images from one particular point in time and, therefore, require a temporal component to the images—i.e., images taken at different periods of time of day/month/year/season, etc.—in order to determine damage. Thus, in some embodiments, the RFDA system 100 uses a series of ‘crop damage’ models in a pipeline to determine whether a farmer, for example, needs to come back at a later time to take an image that will represent damage in a way that might result in claims fulfillment. For example, many times damage may be of fields which are flooded (inundated), and for which the farmer needs to wait for the water to recede to tell if the plants will survive or die. The images of the flooded fields may be annotated with labels (e.g., “inundated”) which don't allow for a current damage assessment, but which could be used in a separate model to allow the determination (show me this field 10 days from now′) and guidance to be given to the farmer. This may be in the form of an amended or follow-up customized workflow sent to the user device to guide the user to take additional images for damage analysis.

At 320, the payout system 162 uses the payout ML model to determine a payout based on the damage determined at 318, and then send payment to the user.

In the RFDA system 100 described above, multiple ML models were discussed and described. In some embodiments described above, the disclosed system and method can include an assessor-in-the-loop machine learning framework as shown and described with respect to FIG. 4, that speeds up and automates the evaluation process with a focus on reducing the assessors' workload and cost. This ML framework is built upon assessors' evaluations and can be continuously improved in an automatic way along with the continual use of the system. This ML component using data collected on site can improve damage assessment whether it is done on site or remotely. The steps for this ML framework are:

In FIG. 4, before the system is launched, an adequate amount of assessment data 402 needs to be collected and evaluated by assessors manually. This assessment data 402 would be used to train the first ML model and kickstart the system.

The ML evaluator 404 (e.g., damage assessment system 144 and damage assessment ML model 146 in FIG. 1) used in this framework receives assessment data 402 and divides its prediction outputs into two categories: “sure” or “confident” evaluations 406 and “unsure” evaluations 408. “Sure” evaluations 406 indicates a known class with a high confidence in the predicted result, and “unsure” evaluations 408 indicates either an unknown class, a low confidence, or a combination of both. As noted above, in some embodiments, the confidence level threshold is configurable and may be based on business goals. The confidence level required to consider a given image as representing “damage” or as requiring an assessor to step in can be tuned (e.g., can be a sliding scale depending on various factors and not just 2 categories).

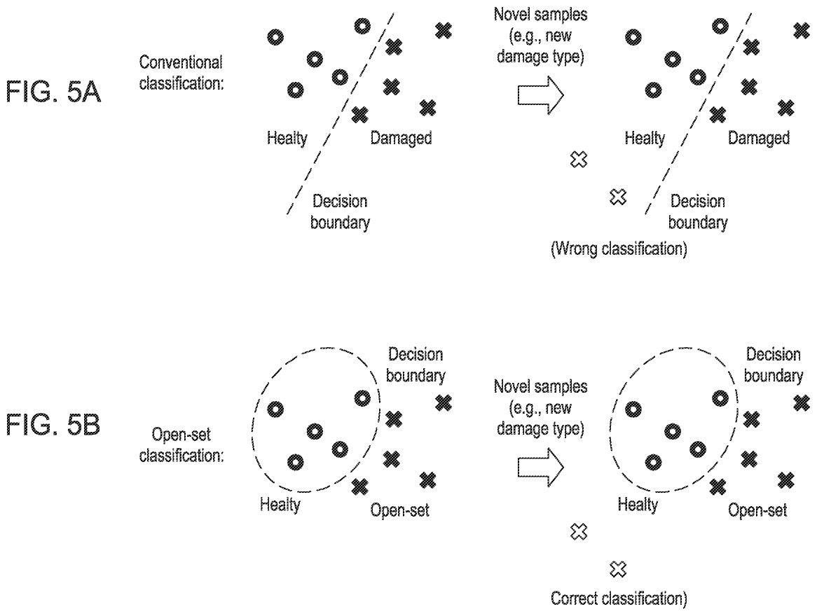

The ML evaluator 404 can be a set of classifiers or regressors, each customized for a crop type and a damage type, or a combined single classifier/regressor that can handle all insured crop and damage types. These classifiers/regressors will evaluate the healthiness of crops based on the assessment data provided and produce outputs like: (1) healthy vs damaged, (2) healthy, slightly damaged, moderately damaged, etc. or (3) damage degree 27%. In each case, they may also output “unsure” instead of a certain class or number. One way to realize such classifiers/regressors is to use an open-set recognition architecture described below with respect to FIGS. 5A and 5B.

The ML system may also adjust its outputs according to global events (e.g., flood or drought in the wider region). These global events adjustments 410 can be extracted from external data sources (e.g., 170 in FIG. 1) such as satellite images or weather data. For example, knowing a tropical cyclone is hitting a certain region, the ML system will increase the likelihood and confidence of a flood damage assessment in that region. This global events adjustment 410 component can be either integrated with the classifiers/regressors of the ML evaluator or cascaded after them.

If the ML evaluator 404 produces a prediction with high confidence (i.e., considered “sure”) 406, the result is then directly sent to the payout estimation process 412. Otherwise, if the ML evaluator outputs “unsure” 408, the claim is then sent to a human assessor 414 for manual evaluation. After a claim is evaluated by a human assessor 414, the assessment data and the evaluation results (including potential reasoning for the results) are sent to and saved by the ML system. The input data and results of the ML-evaluated claims are also saved by the system separately.

In some embodiments, the farmer may dispute an evaluation result directly predicted by the ML evaluator 404. In such a case, the claim may go back at 416 to a human assessor 414 as if the prediction was “unsure”. However, this dispute step may not be a part of the overall system if unneeded for a particular case.

In some embodiments, the insurance company can schedule periodic examination 420 of the ML evaluation results, during which human assessors will look at randomly sampled claims that were confidently evaluated by the ML evaluator and see if they agree with the evaluation results. If they disagree, the claim will be reassessed, and the new data will be sent to and saved by the ML system. This step can be added in or deleted as commensurate with particular use cases.

Automatic ML system update. The ML system can automatically update itself with continual use. The ML models in the system are retrained or updated using all or part of the data described above. When using part of the data for training, the other part (or a subset of it) can be used as holdout validation data. This automatic system update can be scheduled periodically (e.g., every three months), whenever there are enough new training data, or using a combination of both. Models can either be retrained using all old and new training data (can be limited to a time range, e.g., in the last five years), or be updated from the working models using fine-tuning or online methods. The new models will be validated against the holdout validation data and previous ML-evaluated claims. If the performance is satisfactory, the new system with the new models will be automatically deployed.

One way to implement the ML evaluator is to use an open-set recognition architecture. Unlike some classifiers which divide the entire feature space or latent space into multiple mutually exclusive and collectively exhaustive regions, open-set recognition leaves part of the feature/latent space as open space, which represents the “unknown unknowns” of input samples. FIGS. 5A and 5B provide an illustrative example, in which there is a single class “healthy” and all samples of damaged plants are considered to be in the open space. FIGS. 5A and 5B show that the open-set recognition architecture works better on novel, unseen samples compared to conventional classification. Alternatively, the open-set recognition system can use multiple classes, e.g., “healthy”, “slightly damaged”, “severely damaged”, and the outputs would either be one of these classes or be in the open space which indicates unknown samples (“unsure”). In some embodiments, conventional classifiers with a class that says “others” (i.e., not crops we are looking at) may be used to realize classifiers/regressors that will be used to evaluate the healthiness of crops based on the assessment data provided. Still, in other embodiments, a classifier with a plurality of classes that includes common objects and classifies all of the common objects may be used to realize classifiers/regressors that will be used to evaluate the healthiness of crops based on the assessment data provided.

Embodiments of a remote farm damage assessment (RFDA) system 100 and associated components, devices, and processes described can be implemented in a computing device 600 in accordance with the present principles. Data associated with a remote farm damage assessment (RFDA) system 100 in accordance with the present principles can be presented to a user using an output device of the computing device 600, such as a display, a printer, or any other form of output device.

For example, FIG. 1 depicts a high-level block diagrams of computing devices 102, 130, 140, 150 and 160 suitable for use with embodiments of a remote farm damage assessment system in accordance with the present principles. In some embodiments, the computing device 600 can be configured to implement methods of the present principles as processor-executable executable program instructions 622 (e.g., program instructions executable by processor(s) 610) in various embodiments.

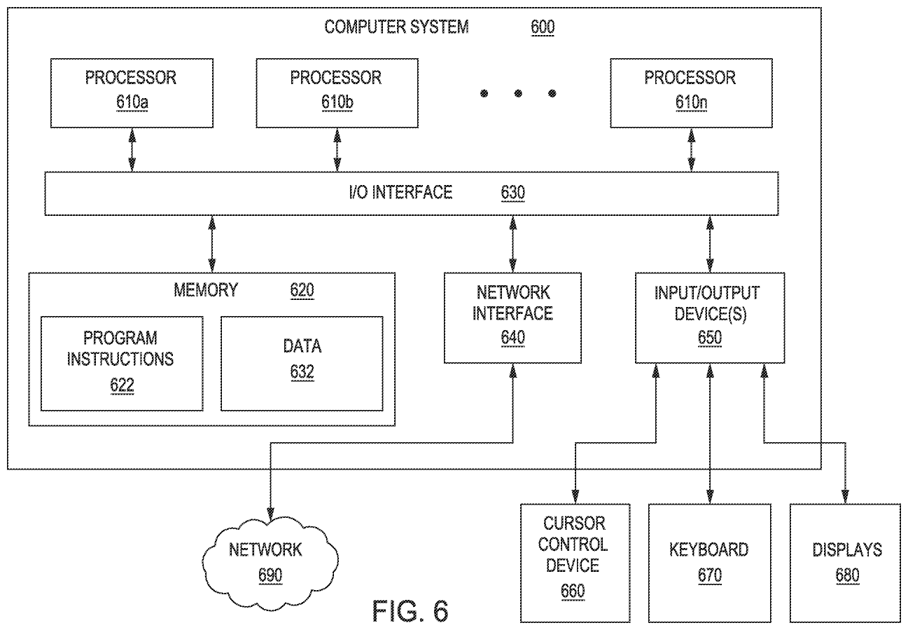

In embodiments consistent with FIG. 6, the computing device 600 includes one or more processors 610a-610n coupled to a system memory 620 via an input/output (I/O) interface 630. The computing device 600 further includes a network interface 640 coupled to I/O interface 630, and one or more input/output devices 650, such as cursor control device 660, keyboard 670, and display(s) 680. In various embodiments, a user interface can be generated and displayed on display 680. In some cases, it is contemplated that embodiments can be implemented using a single instance of computing device 600, while in other embodiments multiple such systems, or multiple nodes making up the computing device 600, can be configured to host different portions or instances of various embodiments. For example, in one embodiment some elements can be implemented via one or more nodes of the computing device 600 that are distinct from those nodes implementing other elements. In another example, multiple nodes may implement the computing device 600 in a distributed manner.

In different embodiments, the computing device 600 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 600 can be a uniprocessor system including one processor 610, or a multiprocessor system including several processors 610 (e.g., two, four, eight, or another suitable number). Processors 610 can be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 can be configured to store program instructions 622 and/or data 632 accessible by processor 610. In various embodiments, system memory 620 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 620. In other embodiments, program instructions and/or data can be received, sent or stored upon different types of computer-accessible media or on similar media separate from system memory 620 or computing device 600.

In one embodiment, I/O interface 630 can be configured to coordinate I/O traffic between processor 610, system memory 620, and any peripheral devices in the device, including network interface 640 or other peripheral interfaces, such as input/output devices 650. In some embodiments, I/O interface 630 can perform any necessary protocol, timing or other data transformations to convert data signals from one component (e.g., system memory 620) into a format suitable for use by another component (e.g., processor 610). In some embodiments, I/O interface 630 can include support for devices attached through various types of peripheral buses, such as a variant of the Peripheral Component Interconnect (PCI) bus standard or the Universal Serial Bus (USB) standard, for example. In some embodiments, the function of I/O interface 630 can be split into two or more separate components, such as a north bridge and a south bridge, for example. Also, in some embodiments some or all of the functionality of I/O interface 630, such as an interface to system memory 620, can be incorporated directly into processor 610.

Network interface 640 can be configured to allow data to be exchanged between the computing device 600 and other devices attached to a network (e.g., network 690), such as one or more external systems or between nodes of the computing device 600. In various embodiments, network 690 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 650 can, in some embodiments, include one or more display terminals, keyboards, keypads, touchpads, scanning devices, voice or optical recognition devices, or any other devices suitable for entering or accessing data by one or more computer systems. Multiple input/output devices 650 can be present in computer system or can be distributed on various nodes of the computing device 600. In some embodiments, similar input/output devices can be separate from the computing device 600 and can interact with one or more nodes of the computing device 600 through a wired or wireless connection, such as over network interface 640.

Those skilled in the art will appreciate that the computing device 600 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 600 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 600 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 600 can further include a web browser.

Although the computing device 600 is depicted as a general purpose computer, the computing device 600 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

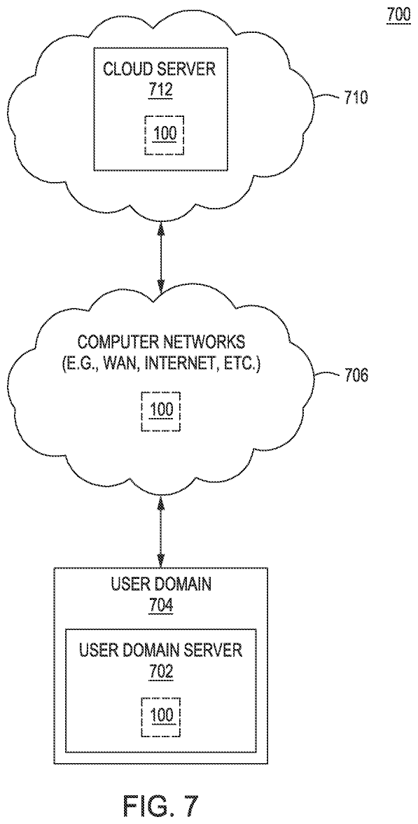

FIG. 7 depicts a high-level block diagram of a network in which embodiments of an RFDA system 100 in accordance with the present principles, such as the RFDA system 100 of FIG. 1, can be applied. The network environment 700 of FIG. 7 illustratively comprises a user domain 702 including a user domain server/computing device 704. The network environment 700 of FIG. 7 further comprises computer networks 706, and a cloud environment 710 including a cloud server/computing device 712.

In the network environment 700 of FIG. 7, a system for remote farm damage assessment in accordance with the present principles, such as the system 100 of FIG. 1, can be included in at least one of the user domain server/computing device 704, the computer networks 706, and the cloud server/computing device 712. That is, in some embodiments, a user can use a local server/computing device (e.g., the user domain server/computing device 704) to provide remote farm damage assessment in accordance with the present principles.

In some embodiments, a user can implement a system for remote farm damage assessment in the computer networks 706 to provide remote farm damage assessment in accordance with the present principles. Alternatively or in addition, in some embodiments, a user can implement a system for remote farm damage assessment in the cloud server/computing device 712 of the cloud environment 710 to provide remote farm damage assessment in accordance with the present principles. For example, in some embodiments it can be advantageous to perform processing functions of the present principles in the cloud environment 710 to take advantage of the processing capabilities and storage capabilities of the cloud environment 710.

In some embodiments in accordance with the present principles, a system for providing remote farm damage assessment can be located in a single and/or multiple locations/servers/computers to perform all or portions of the herein described functionalities of a system in accordance with the present principles. For example, in some embodiments, various systems, modules and machine learning models of an RFDA system 100 can be located in one or more than one of the user domain 702, the computer network environment 706, and the cloud environment 710 for providing the functions described above either locally or remotely.

In some embodiments, remote farm damage assessment can be provided as a service, for example via software. In such embodiments, the software of the present principles can reside in at least one of the user domain server/computing device 704, the computer networks 706, and the cloud server/computing device 712. Even further, in some embodiments software for providing the embodiments of the present principles can be provided via a non-transitory computer readable medium that can be executed by a computing device at any of the computing devices at the user domain server/computing device 704, the computer networks 706, and the cloud server/computing device 712.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 600 can be transmitted to the computing device 600 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. When provided as software, embodiments of the present principles can reside in at least one of a computing device, such as in a local user environment, a computing device in an Internet environment and a computing device in a cloud environment. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for providing remote farm damage assessment, comprising:
determining a set of damage assessment locales for damage assessment;
incorporating the set of damage assessment locales into a workflow;
providing the workflow to a user device;
receiving a first set of damage assessment images from the user device based on the workflow provided, wherein each of the first set of damage assessment images includes geolocation information and camera information;
determining a damage assessment based on the first set of damage assessment images using a damage assessment machine learning model; and
outputting a damage assessment indication including one or more of whether there is damage, a confidence level of assessing the damage, or a confidence level associated with the level of damage.

2. The method of claim 1, wherein damage assessment is based on content included within a defined a region of interest (ROI) in one or more damage assessment images, wherein the ROI is divided into one or more smaller patches of images, and wherein damage assessment results on an analysis of the one or more smaller patches of images are aggregated to reach image-level damage assessment decisions.

3. The method of claim 1, wherein the camera information included with each of the first set of damage assessment images includes one or more of heading of the camera, pitch of the camera, tilt of the camera, image collection date and time, light levels, camera settings, or phone type.

4. The method of claim 1, further comprising:
determining whether any of the first set of damage assessment images is not acceptable for use for damage assessment by analyzing quality of each of the first set of damage assessment images.

5. The method of claim 4, wherein analyzing the quality of each of the first set of damage assessment images includes checking for one or more of image blur, lighting, occlusion, bad angles, or crop centering.

6. The method of claim 4, wherein determining whether any of the first set of damage assessment images is not acceptable for use for damage assessment further comprises:
for each image in the first set of damage assessment images, compute a quality score of the image; and
if the computed quality scores for an image does not exceed a quality threshold, provide feedback to the user device to instruct the user to capture additional images.

7. The method of claim 1, further comprising:
determining an insurance claim payout based on the determined damage assessment using a claim payout machine learning model.

8. The method of claim 1, wherein the damage assessment machine learning model is trained using one or more of annotated images indicating crop information, unsupervised learning, a mixture of annotated and unannotated data, or images annotated at a portion level of an image level or entire image.

9. The method of claim 1, wherein determining an insurance claim payout based on the determined damage assessment using a claim payout machine learning model includes interpolating multi-year data damage assessment from a plurality of samples using statistical techniques or ML based learning.

10. The method of claim 1, wherein the workflow guides a user via a user device to each of the damage assessment locales, and instructs the user to take a first set of damage assessment images, and wherein the damage assessment locales includes both position and orientation of the viewpoint of the damage assessment images.

11. The method of claim 1, wherein the determination of the set of damage assessment locales for damage assessment automatically selects the damage assessment locales using an algorithm based on at least one of 1) information from crop cutting experiments (CCE), 2) expert knowledge, or 3) agricultural heuristics.

12. A method for providing remote farm damage assessment on a mobile device, comprising:
initiating a request to assess crop damage via a mobile device;
downloading a guidance workflow from a second device;
requesting that a user of the mobile device go to each of the damage assessment locales using the downloaded guidance workflow on the mobile device;
capturing a first set of damage assessment images in accordance with guidance from the customized guidance workflow;
determining whether any of the first set of damage assessment images is not acceptable for use for damage assessment by analyzing quality of each of the first set of damage assessment images; and
transmitting the first set of damage assessment images that are determined to be acceptable for use to assess damage to the second device.

13. The method of claim 12, further comprising:
capturing geolocation information and camera information with each of the first set of damage assessment images captured; and
transmitting the geolocation information and camera information to the second device along with the captured images.

14. The method of claim 13, wherein the camera information captured includes one or more of heading of the camera, pitch of the camera, tilt of the camera, image collection date and time, light levels, camera settings, or phone type.

15. The method of claim 12, wherein analyzing the quality of each of the first set of damage assessment images includes checking for one or more of image blur, lighting, occlusion, bad angles, or crop centering.

16. The method of claim 12, wherein determining whether any of the first set of damage assessment images is not acceptable for use for damage assessment further comprises:
for each image in the first set of damage assessment images, compute a quality score of the image; and
if the computed quality scores for an image does not exceed a quality threshold, provide feedback to the mobile device to instruct the user of the mobile device to capture additional images.

17. The method of claim 12, wherein the guidance workflows are customized for a specific user, user device, property, type of crop, growth stage, damage type and/or geolocation.

18. A system for providing remote farm damage assessment, comprising:
a farm sector selection module configured to determine a set of damage assessment locales for damage assessment;
a script engine configured to incorporate the set of damage assessment locales into a workflow, wherein the system is configured to send the workflow to a user device;
a damage assessment system configured to:
receive a first set of damage assessment images from the user device based on the workflow provided, wherein each of the first set of damage assessment images includes geolocation information and camera information;
determining a damage assessment based on the first set of damage assessment images using a damage assessment machine learning model; and
outputting a damage assessment indication including one or more of whether there is damage, a confidence level of assessing the damage, or a confidence level associated with the level of damage.

19. The system of claim 18, wherein the camera information included with each of the first set of damage assessment images includes one or more of heading of the camera, pitch of the camera, tilt of the camera, image collection date and time, light levels, camera settings, or phone type.

20. The system of claim 18, further comprising:
determining whether any of the first set of damage assessment images is not acceptable for use for damage assessment by analyzing quality of each of the first set of damage assessment images.

21. The system of claim 20, wherein analyzing the quality of each of the first set of damage assessment images includes checking for one or more of image blur, lighting, occlusion, bad angles, or crop centering.

22. The system of claim 20, wherein determining whether any of the first set of damage assessment images is not acceptable for use for damage assessment further comprises:
for each image in the first set of damage assessment images, compute a quality score of the image; and
if the computed quality scores for an image does not exceed a quality threshold, provide feedback to the user device to instruct the user to capture additional images.

23. The system of claim 18, further comprising:
a claim payout machine learning model used to determine an insurance claim payout based on the damage assessment indication.

24. The system of claim 18, wherein the damage assessment machine learning model is trained using one or more of annotated images indicating crop information, unsupervised learning, a mixture of annotated and unannotated data, or images annotated at an image level rather than a portion of an image.

25. One or more non-transitory computer readable media having instructions stored thereon which, when executed by one or more processors, cause the one or more processors to perform operations comprising:
determining a set of damage assessment locales for damage assessment;
incorporating the set of damage assessment locales into a workflow;
providing the workflow to a user device;
receiving a first set of damage assessment images from the user device based on the workflow provided, wherein each of the first set of damage assessment images includes geolocation information and camera information;
determining a damage assessment based on the first set of damage assessment images using a damage assessment machine learning model; and
outputting a damage assessment indication including one or more of whether there is damage, a confidence level of assessing the damage, or a confidence level associated with the level of damage.
